(19) United States
(12) Patent Application Publication
(10) Pub. No.: US 2026/0367914 A1
(43) Pub. Date: Nov. 19, 2026

(54) SYSTEMS AND METHODS FOR EXECUTING VECTORIZED SEQUENCE-BASED DATA CHUNKING

(71) Applicant: Acronis International GmbH, Schaffhausen (CH)

(72) Inventors: Sreeharsha Udayashankar, Waterloo (CA); Samer Al-Kiswany, Waterloo (CA)

(21) Appl. No.: 19/208,680

(22) Filed: May 15, 2025

(51) Int. Cl. G06F 9/30

(52) U.S. Cl. CPC G06F 9/30038; G06F 9/30152

(57) ABSTRACT

A system scans a byte stream for data chunks in a byte-by-byte order, wherein the scanning comprises: packing a first amount of adjacent bytes into a plurality of overlapping vector registers, comparing neighboring pairs of the plurality of overlapping vector registers to generate a plurality of masks, wherein each mask comprises one or both of set bits and unset bits, combining the plurality of masks into a combined mask; and marking cut-off points of detected data chunks based on locations of set bits in the combined mask. The system outputs the cut-off points of the detected data chunks.

### FIELD OF TECHNOLOGY

The present disclosure relates to the field of data storage and deduplication, and, more specifically, to systems and methods for executing vectorized sequence-based data chunking.

### BACKGROUND

Data deduplication plays a crucial role in backup systems. It optimizes both storage and bandwidth in said systems by eliminating redundant data. The efficiency of deduplication is significantly low when performed on whole files because any small change between two files can cause them to be treated as different files. Hence, files are usually divided into smaller pieces called chunks. Fixed size chunking is considered the simplest way of dividing files. However, it suffers from a boundary-shift problem, where any addition or removal of the file contents can change all subsequent chunks’ boundaries. This lowers the deduplication efficiency.

Content-defined chunking (CDC) techniques addresses this problem by inserting chunk boundaries based on data attributes rather than relying on a predefined size. This approach achieves better deduplication efficiency, but it is significantly slower compared to fixed-size chunking due to the additional computation overhead needed to find the chunk boundary.

More specifically, conventional CDC techniques often face challenges in achieving a high throughput while maintaining a high deduplication ratio. These limitations can affect the overall efficiency of the deduplication process. In most cases, the file chunking stage tends to be the primary performance bottleneck within most deduplication systems. Accordingly, there exists a need for a new chunking technique that offers a significant increase in chunking speed while maintaining a comparable deduplication ratio to existing CDC techniques.

### SUMMARY

Content-defined Chunking (CDC) algorithms are employed in data deduplication processes to segment data into discrete chunks. Contemporary CDC algorithms exhibit reduced performance, primarily due to the necessity of scanning extensive data volumes and executing intricate boundary determinations. Aspects of the present disclosure describe leveraging vector instructions available on modern CPUs, including the SSE-128, AVX-256, and AVX-512 instruction sets, to enhance the efficiency of chunking algorithms.

In one exemplary aspect, the techniques described herein relate to a method for data chunking, the method including: scanning a byte stream for data chunks in a byte-by-byte order, wherein the scanning includes: packing a first amount of adjacent bytes into a plurality of overlapping vector registers that are overlapping; comparing neighboring pairs of the plurality of overlapping vector registers to generate a plurality of masks, wherein each mask includes one or both of set bits and unset bits; combining the plurality of masks into a combined mask; and marking cut-off points of detected data chunks based on locations of set bits in the combined mask; and outputting the cut-off points of the detected data chunks.

In some aspects, the techniques described herein relate to a method, wherein packing the first amount of adjacent bytes into the plurality of overlapping vector registers includes: generating a second amount of vector registers for inclusion in the plurality of overlapping vector registers; packing a first vector register of the plurality of overlapping vector registers by the first amount of adjacent bytes starting at a first byte; and packing a second vector register of the plurality of overlapping vector registers by the first amount of adjacent bytes starting at a second byte adjacent to the first byte.

In some aspects, the techniques described herein relate to a method, wherein comparing the neighboring pairs of the plurality of overlapping vector registers to generate the plurality of masks includes comparing corresponding bytes of a given neighboring pair of vector registers using a greater than operator.

In some aspects, the techniques described herein relate to a method, wherein combining the plurality of masks into the combined mask includes comparing corresponding bytes of the plurality of masks using an and operator.

In some aspects, the techniques described herein relate to a method, wherein marking the cut-off points of the detected data chunks based on the locations of the set bits in the combined mask includes: detecting a set bit in the combined mask; and marking, in the byte stream, a cut-off point after a byte that corresponds to the set bit.

In some aspects, the techniques described herein relate to a method, further including: in response to determining that the combined mask does not include any set bits, comparing one neighboring pair of the plurality of overlapping vector registers to generate another mask; incrementing a jump criteria value based on a number of set bits in the another mask; and in response to determining that the jump criteria value equals a jump trigger value, skipping scanning by a second amount of bytes in the byte stream.

In some aspects, the techniques described herein relate to a method, further including: in response to determining that jump criteria value does not equal the jump trigger value, skipping scanning by the first amount of adjacent bytes in the byte stream.

In some aspects, the techniques described herein relate to a method, wherein comparing the neighboring pairs of the plurality of overlapping vector registers includes using a greater than operator and comparing the one neighboring pair occurs using a less than operator.

In some aspects, the techniques described herein relate to a method, wherein subsequent to detecting at least one set bit in the combined mask and marking at least one cut-off point, skipping scanning by a third amount of bytes in the byte stream.

In some aspects, the techniques described herein relate to a method, wherein the first amount of adjacent bytes is based on a type of vector instruction sets used on a computing device on which the scanning is performed, and wherein the first amount of adjacent bytes differs for a first type of vector instruction set and a second type of vector instruction set.

In some aspects, the techniques described herein relate to a method, wherein the first type of vector instruction set is Streaming Single Instruction, Multiple Data Extensions (SSE)-128, the second type of vector instruction set is Advanced Vector Extensions (AVX)-256, and a third type of vector instruction set is Advanced Vector Extensions (AVX)-512.

It should be noted that the methods described above may be implemented in a system comprising at least one hardware processor and memory. Alternatively, the methods may be implemented using computer executable instructions of a non-transitory computer readable medium.

In some aspects, the techniques described herein relate to a system for data chunking, including: at least one memory; and at least one hardware processor coupled with the at least one memory and configured, individually or in combination, to: scan a byte stream for data chunks in a byte-by-byte order, wherein the scanning includes: packing a first amount of adjacent bytes into a plurality of overlapping vector registers; comparing neighboring pairs of the plurality of overlapping vector registers to generate a plurality of masks, wherein each mask includes one or both of set bits and unset bits; combining the plurality of masks into a combined mask; and marking cut-off points of detected data chunks based on locations of set bits in the combined mask; and output the cut-off points of the detected data chunks.

In some aspects, the techniques described herein relate to a non-transitory computer readable medium storing thereon computer executable instructions for data chunking, including instructions for: scanning a byte stream for data chunks in a byte-by-byte order, wherein the scanning includes: packing a first amount of adjacent bytes into a plurality of overlapping vector registers; comparing neighboring pairs of the plurality of overlapping vector registers to generate a plurality of masks, wherein each mask includes one or both of set bits and unset bits; combining the plurality of masks into a combined mask; and marking cut-off points of detected data chunks based on locations of set bits in the combined mask; and outputting the cut-off points of the detected data chunks.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for executing vectorized sequence-based data chunking.

FIG. 2 is a diagram illustrating an example of jump-based content-defined data chunking.

FIG. 3 is a diagram illustrating an example of vectorized sequence-based data chunking.

FIG. 4 illustrates a flow diagram of a method for executing vectorized sequence-based data chunking.

FIG. 5 illustrates a flow diagram of a method for determining whether to jump in response to detecting no boundaries during vectorized sequence-based data chunking.

FIG. 6 presents an example of a general-purpose computer system on which aspects of the present disclosure can be implemented.

### DETAILED DESCRIPTION

Exemplary aspects are described herein in the context of a system, method, and computer program product for executing vectorized sequence-based data chunking. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

In the context of the present disclosure, consider the following definitions:

A storage system comprises multiple storage servers or a collection of disks, such as hard disk drives (HDDs), which are managed by specialized software designed for archiving and storing data.

User data refers to any digital information stored by the user, including files, software, and databases.

A data stream is a continuous flow of user data intended for archiving.

A chunk is a segment of data produced by dividing the data stream, which enhances the ability to detect duplicates and improves deduplication efficiency.

A fingerprint is the hash value of a chunk, generated using a collision-resistant hashing algorithm like SHA-1.

A content-defined chunking algorithm is employed to divide the data stream into variable-sized chunks, with chunk boundaries determined by the data's content, resulting in varying chunk sizes.

Vector instructions are a form of instructional support provided by CPUs for Single Instruction, Multiple Data (SIMD) processing, enabling the execution of a single operation on multiple data elements simultaneously.

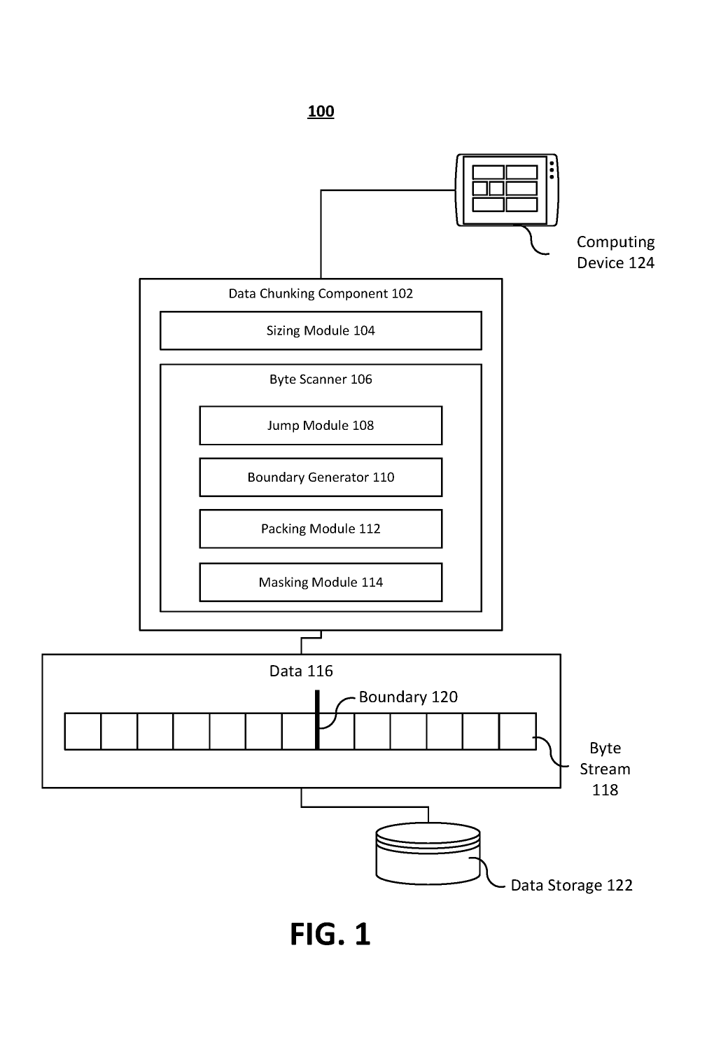

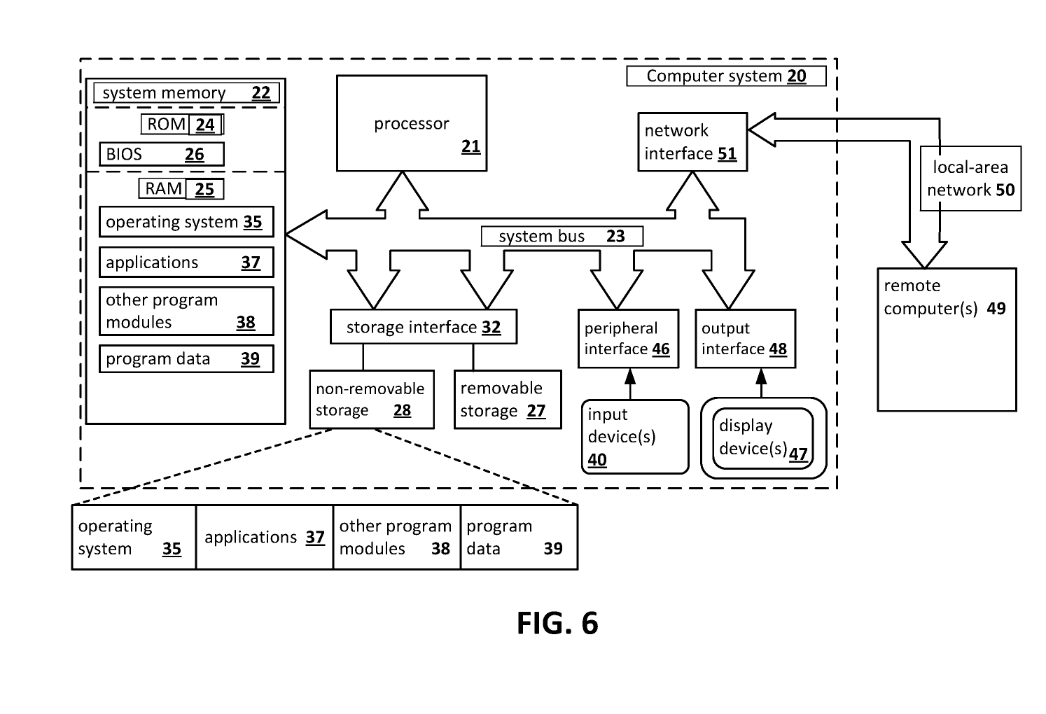

FIG. 1 is a block diagram illustrating system 100 for executing vectorized sequence-based data chunking. System 100 includes computing device 124, which corresponds to computer system 20 in FIG. 6. Computing device 124 executes data chunking component 102, which may be a standalone software or a software component for chunking data streams. For example, data chunking component 102 may create chunks of byte stream 118 within data 116. This involves generating boundaries such as boundary 120 in byte stream 118, isolating the chunks into separate streams, and storing the chunks in data storage 122 along with, in some aspects, metadata for recombining the chunks back into byte stream 118.

Data chunking component 102 includes sizing module 104 and byte scanner 106. Sizing module 104 sets the criteria for data chunk sizing and jump sizes. Byte scanner 106 performs a byte-by-byte scan and generates boundaries (e.g., boundary 120). In an exemplary aspect, byte scanner 106 includes jump module 108 for executing jumps, boundary generator 110 for identifying boundaries, packing module 112 for packing bytes into registers, and masking module 114 for generating masks based on the registers.

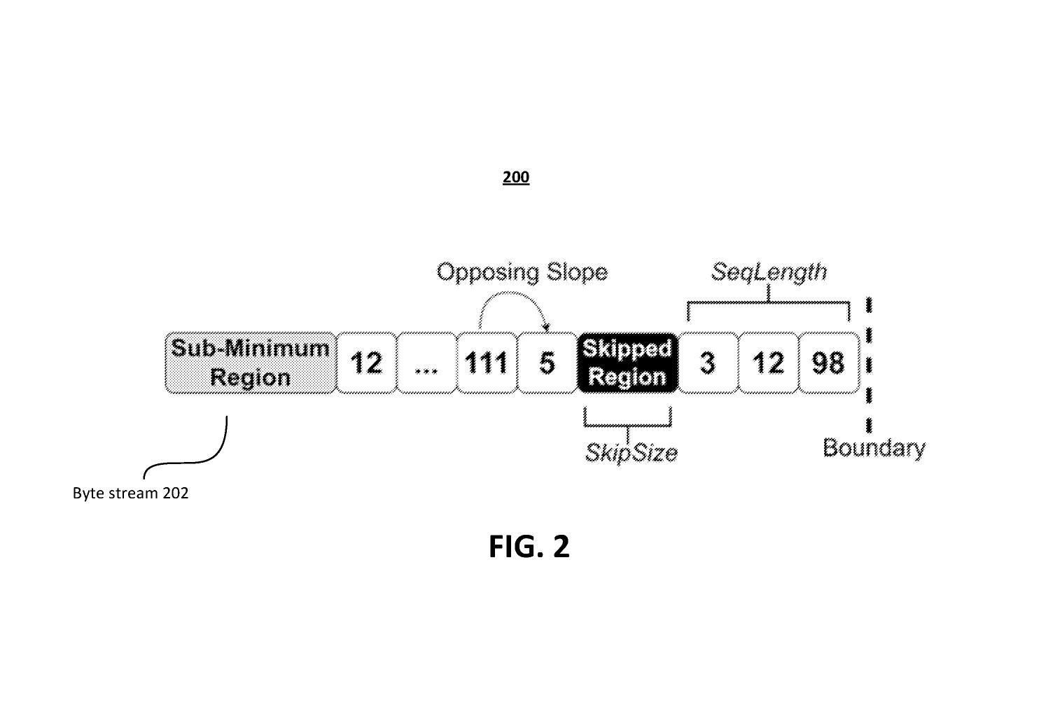

FIG. 2 is a diagram 200 illustrating an example of jump-based content-defined data chunking. Jump-based content-defined data chunking involves monotonically increasing and/or decreasing sequences to detect chunk boundaries. This type of chunking has four configuration parameters: SeqLength, SkipTrigger, SkipSize, and Mode. It also uses minimum, maximum, and average hunk sizes. The parameters have the following definitions:
SeqLength: The length of the boundary sequence to use for chunk boundaries. For instance, a SeqLength of 5 indicates that a chunk boundary is inserted when a sequence of five consecutive monotonically increasing bytes are detected.
SkipTrigger: The number of opposing slope byte pairs to detect before a jump ahead is triggered.
SkipSize: The number of bytes to skip scanning and jump ahead when a jump is triggered.
Mode: Indicates whether to consider monotonically increasing/decreasing sequences as chunk boundary candidates. The two modes of operation are exclusive to each other.

The algorithm works using the following steps. It should be noted that in reference to FIG. 2, the modes set to increasing sequences, but decreasing sequences can be evaluated using similar steps. First, byte scanner 106 starts scanning byte stream 202 (e.g., an example of byte stream 118 of data 116) from left to right. Jump module 108 may then jump ahead by a minimum chunk size bytes. This is the sub-minimum region in FIG. 2.

Sizing module 104 sets current sequence length and current opposing bytes to 0.

Byte scanner 106 then scans byte-by-byte comparing the current byte’s value to the previous byte. If the current byte’s value is greater than the previous byte, sizing module 104 increments current sequence length. Otherwise, sizing module 104 increments current opposing bytes.

If the current sequence length quals SeqLength, oundary generator 110 inserts a chunk boundary and jump module 108 initiates another jump by a minimum chunk size bytes. In FIG. 2, a chunk boundary has been inserted after an increasing sequence of length 3.

If the current opposing bytes qual Skip Trigger, ump module 108 jumps ahead by SkipSize bytes, and sizing module 104 sets current sequence length and current opposing bytes to 0. A skipped region is shown in black in FIG. 2.

If the maximum chunk size s reached, boundary generator 110 inserts a chunk boundary and jump module 108 initiates another jump by a minimum chunk size bytes.

Byte scanner 106 then scans the next byte and repeats these steps until the entire byte stream 202 has been divided.

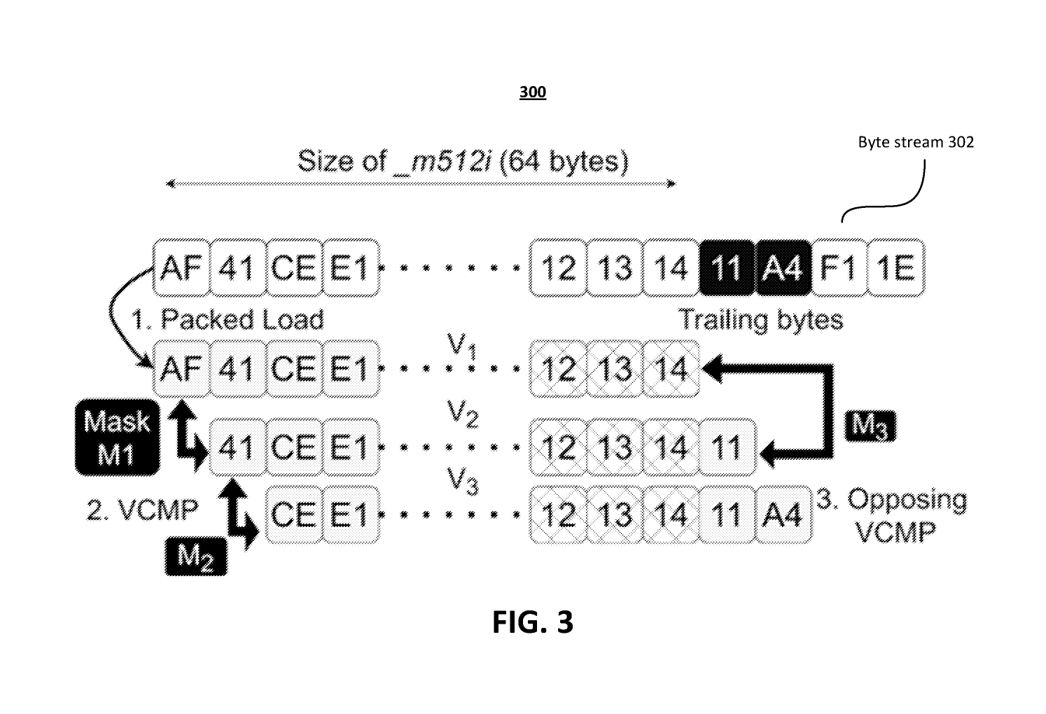

FIG. 3 is a diagram 300 illustrating an example of vectorized sequence-based data chunking. Vectorized sequence-based data chunking accelerates the algorithm described in FIG. 2 using vector CPU instructions. Vector instruction sets, such as SSE-128, AVX-256, and AVX-512, supported by modern CPUs allow for the processing of multiple bytes of data with a single vector instruction. However, their usage requires redesigning the algorithm of FIG. 2.

The example in FIG. 3 for a vectorized version of the algorithm is operating in increasing mode e.g., looking for monotonically increasing sequences with a SeqLength of 3), but works in the same manner for decreasing mode

In an exemplary aspect, byte scanner 106 starts scanning byte stream 302 (e.g., another example of byte stream 118 of data 116) from left to right.

Jump module 108 then jumps ahead by minimum chunk size bytes. Suppose that after the jump, byte scanner 106 arrives at byte “AF” in FIG. 3.

Packing module 112 then packs as many adjacent bytes as possible into a vector register. This varies depending on the instruction set used. For instance, with SSE-128 and 128-bit vector registers, 16 bytes fit into a single vector register. In FIG. 3, suppose there are 9 bytes in each register. For example, bytes “AF” – “14” fit into a single register, V₁.

Byte scanner 106 then moves to the next byte and packing module 112 packs as many bytes as possible into a vector register from this position. In FIG. 3, bytes “41” – “11” are packed into another register, V₂.

These packing steps are repeated SeqLength times until packing module 112 produces a SeqLength amount of vector registers with packed bytes from the data region. In FIG. 3, three registers are produced: V₁, V₂, and V₃. These vector registers are overlapping because they share a majority of byte values and consecutive vector registers have only two differing bytes (e.g., V₁ does not have 11, and V₂ does not have AF).

Masking module 114 then runs a VCMP operation to compare all neighboring pairs of vector registers using the greater than operator. In FIG. 3, masking module 114 runs the operation twice; the first compares V₂to V₁ and the second compares V₃ to V₂ Suppose that in its entirety, V₁ is AF, 41, CE, E1, B2, D5, 12, 13, 14. V₂ is 41, CE, E1, B2, D5, 12, 13, 14, 11. V₃ is CE, E1, B2, D5, 12, 13, 14, 11, A4.

Both operations compare bytes at the same position in both registers. For instance, the VCMP operation between V₂ and V₁ compares byte “41” from V₂ and byte “AF” from V₁ byte “CE” from V₂ and byte “41” from V₁, and so on.

Each operation generates a mask (M₁and M₂). For instance, the mask from the VCMP operation between V₂ and V₁ comprises set bits in all positions where the byte from V₂ is greater than that in V₁. M₁ is 0, 1, 1, 0, 1, 0, 1, 1, 0 and M₂ is 1, 1, 0, 1, 0, 1, 1, 0, 1. Masking module 114 then combines all the masks from using the ‘&’ operator. The resulting combined mask contains set bits only in positions with set bits for all masks. For example, the combined mask M_{c} is 0, 1, 0, 0, 0, 0, 1, 0, 0 meaning the set bits are only in positions where both M₁ and M₂ have set bits.

M_{c} is used in place of current sequence length from the base algorithm described in FIG. 2. Any set bit in this combined mask indicates a chunk boundary at the corresponding byte position. For example, referring to byte stream 302, boundary generator 110 determines that there should be boundaries generated right after the second byte and right after the seventh byte of V₁. If a boundary is detected, jump module 108 jumps ahead by the minimum chunk size bytes in byte stream 302.

If no boundaries are detected, masking module 114 runs a single VCMP between V₁ and V₂ to see if bytes in V₁ are greater than V₂. Note that this is an opposite comparison to those above. This generates mask M₃, which is 1, 0, 0, 1, 0, 1, 0, 0, 1. Sizing module 104 further increments current opposing bytes by the number of set bits in M₃ (e.g., increase by 4).

If current opposing bytes equals SkipTrigger, masking module 114 jumps ahead by SkipSize bytes. The position to jump from depends on the location of the first set bit that causes current opposing bytes to equal SkipTrigger. For example, if the sixth bit is what causes current opposing bytes to equal SkipTrigger, the jump starts from the corresponding sixth byte. he set bit count and jump position are determined using x86 intrinsics accelerated with bit-manipulation CPU instructions (BMI and BMI-2 instruction sets).

f no boundaries are detected and current opposing bytess less than SkipTriggermasking module 114 moves ahead by the number of bytes packed into a single vector register, e.g., 9 bytes. These steps are repeated until the entire data stream is divided into chunks.

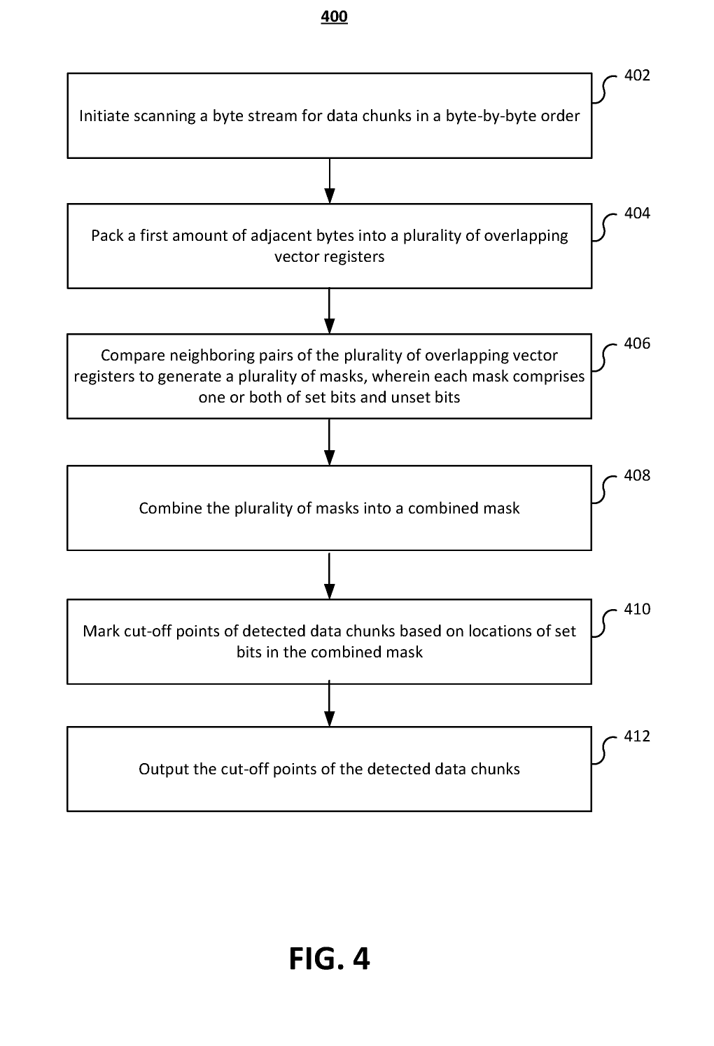

FIG. 4 illustrates a flow diagram of a method 400 for executing vectorized sequence-based data chunking. At 402, data chunking component 102 initiates scanning a byte stream for data chunks in a byte-by-byte order. At 404, data chunking component 102 packs a first amount of adjacent bytes into a plurality of overlapping vector registers. In some aspects, packing involves generating a second amount (e.g., SeqLength) of vector registers for inclusion in the plurality of overlapping vector registers. For example, data chunking component 102 packs a first vector register (e.g., V₁) of the plurality of overlapping vector registers by the first amount of adjacent bytes starting at a first byte (e.g., AF) and packs a second vector register (e.g., V₂) of the plurality of overlapping vector registers by the first amount of adjacent bytes starting at a second byte (e.g., 41) adjacent to the first byte.

In some aspects, the first amount of adjacent bytes is based on a type of vector instruction sets used on a computing device on which the scanning is performed. For example, the first amount of adjacent bytes may differ for a first type of vector instruction set and a second type of vector instruction set. Suppose that in this example, the first type of vector instruction set is Streaming Single Instruction, Multiple Data Extensions (SSE)-128 and the second type of vector instruction set is Advanced Vector Extensions (AVX)-256.

At 406, data chunking component 102 compares neighboring pairs of the plurality of overlapping vector registers (e.g., V₁ to V₂ and V₂ to V₃) to generate a plurality of masks (e.g., M₁, M₂). For example, data chunking component 102 compares corresponding bytes of a given neighboring pair of vector registers using a “greater than” operator (e.g., is a byte of V₁ greater than a corresponding byte of V₂ - if yes, then the result is a set bit). Here, each mask comprises one or both of set bits (e.g., 1) and unset bits (e.g., 0).

At 408, data chunking component 102 combines the plurality of masks into a combined mask (e.g., M_{c}. For example, data chunking component 102 may generate a single mask by comparing corresponding bytes of the plurality of masks using an “and” operator.

At 410, data chunking component 102 marks cut-off points of detected data chunks based on locations of set bits in the combined mask. For example, data chunking component 102 may detect a set bit in the combined mask. Data chunking component 102 may then mark, in the byte stream, a cut-off point after a byte that corresponds to the set bit.

At 412, data chunking component 102 outputs the cut-off points of the detected data chunks (e.g., on a user interface). In some aspects, data chunking component 102 may generate data chunks based on the cut-off points and store said data chunks in data storage 122.

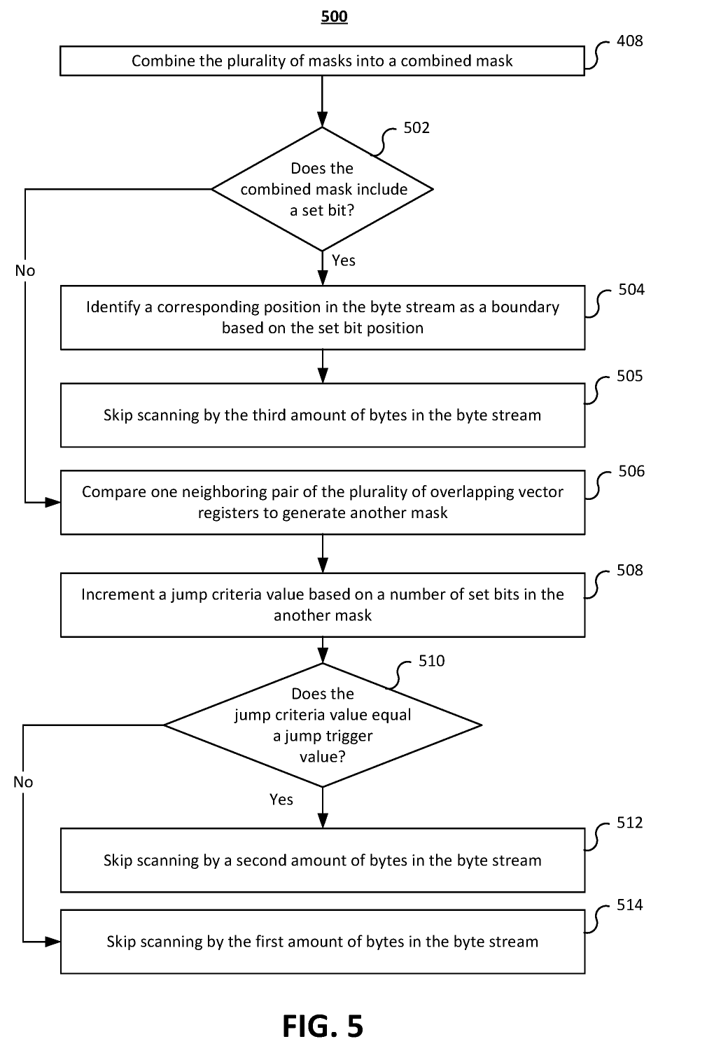

FIG. 5 illustrates a flow diagram of a method 500 for determining whether to jump in response to detecting no boundaries during vectorized sequence-based data chunking.

Method 500 may be triggered from step 408. At 502, data chunking component 102 determines whether the combined mask includes a set bit. In response to determining that the combined mask does not include any set bits, at 506, data chunking component 102 compares one neighboring pair of the plurality of overlapping vector registers to generate another mask (e.g., M₃). It should be noted that comparing the neighboring pairs of the plurality of overlapping vector registers comprises using a “greater than” operator while comparing the one neighboring pair (e.g., V₁ to ₂) occurs using a “less than” operator.

At 508, data chunking component 102 increments a jump criteria value (e.g., current opposing bytes based on a number of set bits in the another mask. At 510, data chunking component 102 determines whether that the jump criteria value equals a jump trigger value (e.g., SkipTrigger. In response to determining that the jump criteria value equals a jump trigger value, at 512, data chunking component 102 skips scanning the next bytes by a second amount of bytes (e.g., SkipSize) in the byte stream.

In response to determining that jump criteria value does not equal the jump trigger value, at 512, data chunking component 102 skips scanning by the first amount of adjacent bytes in the byte stream.

In response to determining that the combined mask includes at least one set bit, at 504, data chunking component 102 identifies a corresponding position in the byte stream as a boundary based on the set bit position. At 506, data chunking component 102 skips scanning the next set of bytes by a third amount of bytes (e.g., minimum chunk sizein the byte stream.

FIG. 6 is a block diagram illustrating a computer system 20 on which aspects of systems and methods for executing vectorized sequence-based data chunking may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I², and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term "module" as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module’s functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer’s specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for data chunking, the method comprising:
scanning a byte stream for data chunks in a byte-by-byte order, wherein the scanning comprises:
packing a first amount of adjacent bytes into a plurality of overlapping vector registers;
comparing neighboring pairs of the plurality of overlapping vector registers to generate a plurality of masks, wherein each mask comprises one or both of set bits and unset bits;
combining the plurality of masks into a combined mask; and
marking cut-off points of detected data chunks based on locations of set bits in the combined mask; and
outputting the cut-off points of the detected data chunks.

2. The method of claim 1, wherein packing the first amount of adjacent bytes into the plurality of overlapping vector registers comprises:
generating a second amount of vector registers for inclusion in the plurality of overlapping vector registers;
packing a first vector register of the plurality of overlapping vector registers by the first amount of adjacent bytes starting at a first byte; and
packing a second vector register of the plurality of overlapping vector registers by the first amount of adjacent bytes starting at a second byte adjacent to the first byte.

3. The method of claim 1, wherein comparing the neighboring pairs of the plurality of overlapping vector registers to generate the plurality of masks comprises comparing corresponding bytes of a given neighboring pair of vector registers using a greater than operator.

4. The method of claim 1, wherein combining the plurality of masks into the combined mask comprises comparing corresponding bytes of the plurality of masks using an and operator.

5. The method of claim 1, wherein marking the cut-off points of the detected data chunks based on the locations of the set bits in the combined mask comprises:
detecting a set bit in the combined mask; and
marking, in the byte stream, a cut-off point after a byte that corresponds to the set bit.

6. The method of claim 1, further comprising:
in response to determining that the combined mask does not include any set bits, comparing one neighboring pair of the plurality of overlapping vector registers to generate another mask;
incrementing a jump criteria value based on a number of set bits in the another mask; and
in response to determining that the jump criteria value equals a jump trigger value, skipping scanning by a second amount of bytes in the byte stream.

7. The method of claim 6, further comprising:
in response to determining that jump criteria value does not equal the jump trigger value, skipping scanning by the first amount of adjacent bytes in the byte stream.

8. The method of claim 6, wherein comparing the neighboring pairs of the plurality of overlapping vector registers comprises using a greater than operator and comparing the one neighboring pair occurs using a less than operator.

9. The method of claim 1, wherein subsequent to detecting at least one set bit in the combined mask and marking at least one cut-off point, skipping scanning by a third amount of bytes in the byte stream.

10. The method of claim 1, wherein the first amount of adjacent bytes is based on a type of vector instruction sets used on a computing device on which the scanning is performed, and wherein the first amount of adjacent bytes differs for a first type of vector instruction set and a second type of vector instruction set.

11. The method of claim 10, wherein the first type of vector instruction set is Streaming Single Instruction, Multiple Data Extensions (SSE)-128 and the second type of vector instruction set is Advanced Vector Extensions (AVX)-256.

12. A system for data chunking, comprising:
at least one memory; and
at least one hardware processor coupled with the at least one memory and configured, individually or in combination, to:
scan a byte stream for data chunks in a byte-by-byte order, wherein the scanning comprises:
packing a first amount of adjacent bytes into a plurality of overlapping vector registers;
comparing neighboring pairs of the plurality of overlapping vector registers to generate a plurality of masks, wherein each mask comprises one or both of set bits and unset bits;
combining the plurality of masks into a combined mask; and
marking cut-off points of detected data chunks based on locations of set bits in the combined mask; and
output the cut-off points of the detected data chunks.

13. The system of claim 12, wherein the at least one hardware processor is configured to pack the first amount of adjacent bytes into the plurality of overlapping vector registers by:
generating a second amount of vector registers for inclusion in the plurality of overlapping vector registers;
packing a first vector register of the plurality of overlapping vector registers by the first amount of adjacent bytes starting at a first byte; and
packing a second vector register of the plurality of overlapping vector registers by the first amount of adjacent bytes starting at a second byte adjacent to the first byte.

14. The system of claim 12, wherein the at least one hardware processor is configured to compare the neighboring pairs of the plurality of overlapping vector registers to generate the plurality of masks by comparing corresponding bytes of a given neighboring pair of vector registers using a greater than operator.

15. The system of claim 12, wherein the at least one hardware processor is configured to combine the plurality of masks into the combined mask by comparing corresponding bytes of the plurality of masks using an and operator.

16. The system of claim 12, wherein the at least one hardware processor is configured to mark the cut-off points of the detected data chunks based on the locations of the set bits in the combined mask by:
detecting a set bit in the combined mask; and
marking, in the byte stream, a cut-off point after a byte that corresponds to the set bit.

17. The system of claim 12, wherein the at least one hardware processor is configured to:
in response to determining that the combined mask does not include any set bits, compare one neighboring pair of the plurality of overlapping vector registers to generate another mask;
increment a jump criteria value based on a number of set bits in the another mask; and
in response to determining that the jump criteria value equals a jump trigger value, skip scanning by a second amount of bytes in the byte stream.

18. The system of claim 17, wherein the at least one hardware processor is configured to:
in response to determining that jump criteria value does not equal the jump trigger value, skip scanning by the first amount of adjacent bytes in the byte stream.

19. The system of claim 17, wherein the at least one hardware processor is configured to compare the neighboring pairs of the plurality of overlapping vector registers by using a greater than operator and comparing the one neighboring pair occurs using a less than operator.

20. A non-transitory computer readable medium storing thereon computer executable instructions for data chunking, including instructions for:
scanning a byte stream for data chunks in a byte-by-byte order, wherein the scanning comprises:
packing a first amount of adjacent bytes into a plurality of overlapping vector registers;
comparing neighboring pairs of the plurality of overlapping vector registers to generate a plurality of masks, wherein each mask comprises one or both of set bits and unset bits;
combining the plurality of masks into a combined mask; and
marking cut-off points of detected data chunks based on locations of set bits in the combined mask; and
outputting the cut-off points of the detected data chunks.
